(19) United States
(12) Patent Application Publication
(10) Pub. No.: US 2008/0299437 A1
(43) Pub. Date: Dec. 4, 2008

(54) POLYELECTROLYTE MEMBRANE FOR ELECTROCHEMICAL APPLICATIONS, IN PARTICULAR FOR FUEL CELLS

(75) Inventors: Teresa Napolitano, Cimitile (NA) (IT); Anna Borriello, Portici (NA) (IT); Pasquale Agoretti, Casoria (NA) (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.l., Agrate Brianza (MI) (IT)

(21) Appl. No.: 12/126,568

(22) Filed: May 23, 2008

(30) Foreign Application Priority Data
May 31, 2007 (IT) MI2007A001114

(51) Int. Cl. H01M 8/10; C08F 8/36

(52) U.S. Cl. 429/33; 264/331.11; 525/344

(57) ABSTRACT

A polyelectrolyte membrane may include at least one styrene polymer or copolymer having a syndiotactic configuration and having sulfonic groups. The at least one styrene polymer or copolymer may be made in the form of a film in clathrate form. The film may include less than about 0.1% sulfonate groups of —SO₃⁻Y⁺ general formula, in which Y may be a monovalent metal cation.

### FIELD OF THE INVENTION

In its most general aspect, the present invention regards a polyelectrolyte membrane for electrochemical applications, and in particular for fuel cells. In particular, the present invention regards a polyelectrolyte membrane for the aforesaid applications, which can be produced by forming a polyelectrolyte into a film. Moreover, the present invention regards a method for producing the aforesaid polyelectrolyte membrane as well as a fuel cell which uses the aforesaid polyelectrolyte membrane.

### BACKGROUND OF THE INVENTION

In the last few years, attention has been turned towards new energy techniques, in view of environmental impact problems. One new energy technique of considerable importance is represented by the fuel cell. The fuel cell converts chemical energy into electrical energy by making hydrogen react with oxygen in an electrochemical manner. It also shows a high energy efficiency.

Conventional fuel cells have been classified according to the electrolyte type used, for example, into fuel cells of phosphoric acid type, fuel cells of molten carbonate type, fuel cells of solid oxide type, and fuel cells of solid polymer type.

As a hydrogen source for the fuel cells, methanol, natural gases, and the like have been used, which are converted or transformed into hydrogen in the fuel cells. Among these fuel cells, those of solid polymer type that use a polyelectrolyte membrane (high molecular weight polymer ion exchange membrane) as electrolyte, have a simple structure and are easy to maintain. Moreover, it is expected that they may be applied in the automotive field.

The main function of the membrane in the fuel cell is to transport protons from the anode, where they are formed by decomposition of the hydrogen gas, to the cathode, wherein the protons react with oxygen gas and electrons to form water (see FIG. 1). In addition, the membrane should provide a barrier to the gas and should physically separate the electrodes. In order to satisfy these functions, the membrane should be prepared from a polymer having excellent mechanical, thermal, hydrolytic, oxidative, and reductive stability. This typically requires the use of very stable polymers which normally limit the choice of materials.

Currently, membranes of Naphion type, available from DuPont, or the like are well known materials on the market.

The membranes of Naphion type include perfluorinated resins having a perfluoroalkylether side chain with a sulfonic acid group at its end. Even if such membranes satisfy many of the abovementioned requirements, they have several disadvantages. These disadvantages mainly include a high cost of the materials which form the membranes. Additionally, the membranes show an unacceptable methanol crossover and a high water transport rate, and show completely unsuitable properties above 100° C., a very important emerging condition for which the membranes will be used.

A recent development in the sector of the proton exchange polyelectrolyte polymer membranes is represented by the sulfonation of syndiotactic polystyrene (s-PS) and atactic polystyrene (a-PS). In particular, EP 1,494,307 describes a polyelectrolyte membrane comprising at least one styrene polymer or copolymer having a syndiotactic configuration and having sulfonic groups the at least one styrene polymer or copolymer is made in the form of a film in which at least one styrene polymer or copolymer is in clathrate form. The sulfonic groups being introduced in the film by reaction of the film with chlorosulfonic acid and subsequent hydrolysis of the chlorosulfonic groups.

The membrane according to such patent has good conductive properties and can be produced at relatively low cost, and with a reduction of the number of process steps with respect to those based on Nafion. Nevertheless, its electric conductivity, while satisfactory, is less than that of the Naphion type membrane.

Hence, there is the need to provide a polyelectrolyte membrane for electrochemical applications, in particular for fuel cells of small size, having improved electrical conductivity properties, and which can be produced in a simple manner and at lower costs.

### SUMMARY OF THE INVENTION

In view of the foregoing background, it is therefore an object of the invention to provide a polyelectrolyte membrane for electrochemical applications, in particular, for fuel cells of small size which satisfies the aforesaid need.

This object is provided by a polyelectrolyte membrane comprising at least one styrene polymer or copolymer having a syndiotactic configuration and having sulfonic groups. The at least one styrene polymer or copolymer is made in the form of a film, in which at least one styrene polymer or copolymer is in clathrate form. The film comprises less than 0.1% of sulfonate groups of general formula —SO₃⁻Y⁺, wherein Y is a monovalent metal cation, in particular Na+.

The term clathrate form refers to the trapping of compounds into cavities, preferably in regularly spaced nanocavities present in the crystalline phase of the styrene polymers or copolymers, forming the so-called inclusion compounds therein. Generally, such compounds are molecules of solvents used for preparing styrene polymers and copolymers, as will be explained below.

The styrene polymers and copolymers used have a substantially syndiotactic configuration and are obtained in a nanoporous crystalline form and by polymerisation of styrene with olefins having the formula CH₂═CH—R, in which R is an alkyl-aryl group or a substituted aryl group having from about 6 to 20 carbon atoms, or with other monomer compounds having unsaturated ethylene groups.

Representative and non-limiting examples of the styrene polymers or copolymers are poly(p-methylstyrene), poly(m-methylstyrene), poly(p-chlorostyrene), poly(m-chlorostyrene), poly(chloromethylstyrene), poly(bromostyrene), poly(fluorostyrene), etc. The styrene polymer preferably used is syndiotactic polystyrene in its clathrate form. The average molecular weight of the syndiotactic styrene polymer or copolymer is not particularly restricted. In the case of syndiotactic polystyrene, it is preferably higher than about 10,000 and, more particularly, in the range of about 100,000-1,500,000. The sulfonic group content (—SO₃H) in the membrane is in the range of about 1-60%, and preferably in the range of about 5-30% of the molar concentration.

Moreover, such an approach may include a method for producing a polyelectrolyte membrane comprising at least one syndiotactic styrene polymer or copolymer in its clathrate form and having sulfonic groups. The method may include providing a film containing at least one syndiotactic styrene polymer or copolymer in clathrate form, and introducing halogen sulfonic groups into the film by reaction of the film with a halogen sulfonic acid. The method further may include hydrolysing the halogen sulfonic groups with a base, thus obtaining a polyelectrolyte membrane comprising sulfonic groups (—SO₃H) and sulfonate groups (—SO₃—Y+). The method may also include acidifying the membrane, thus, obtained with an acid in order to form sulfonic groups (—SO₃H) from sulfonate groups (—SO₃—Y+).

As the result of extensive studies, the inventors have found that by introducing halogen sulfonic groups, using a halogen sulfonic acid, for example, chlorosulfonic acid, in a film formed by a syndiotactic styrene polymer or copolymer in clathrate form, for example, syndiotactic polystyrene in its clathrate form, and acidifying the previously hydrolysed membrane, there is a large increase of sulfonic groups, which leads to improved conductivity. Similar results were also found for polyelectrolyte membranes obtained from syndiotactic styrene polymers or copolymers in clathrate form, in addition to syndiotactic polystyrene in its clathrate form.

Presently, what is intended by halogen sulfonic acid is a compound with HOSO₂X general formula wherein X can be one of the following: Cl, Br, I, F. The halogen sulfonic acid is preferably chlorosulfonic acid. Chlorosulfonic acid is particularly suitable due to its strong sulfonating agent qualities. The halogen sulfonic acid is preferably in a solution of a solvent capable of inducing, in the sPS films, the clathrate form characteristic essential for the targeted sulfonation of the membrane.

Preferably, such solvent is selected from the group consisting of chloroform, methyl chloride, methylene chloride, carbon tetrachloride, dichloroethane, trichloroethylene, tetrachloroethylene, dibromoethane, methyl iodide, aromatic compounds such as benzene, o-dichlorobenzene, toluene, styrene, cyclic compounds, such as, for example, cyclohexane, tetrahydrofuran, and compounds containing sulphur such as, for example, carbon sulfide. Preferably, the solvent is chloroform. Chloroform, in fact, is preferably used since in addition to being a clathrating solvent, it is quickly evaporating. Preferably, the halogen sulfonic acid is present in solution at a volumetric concentration in the range of about 0.001-60%, in particular 1-60%.

As an intermediate product of the sulfonation of the film with a halogen sulfonic acid, halogen sulfonic groups are formed in the film, for example —SO₂Cl groups, if chlorosulfonic acid is used, according to the following reaction scheme:

2HOSO₂Cl=H₂⁺O—SO₂Cl+SO₃+Cl⁻=⁺SO₂Cl+HCl+HSO₄⁻

Ar+⁺SO₂Cl+HSO₄⁻+HCl→ArSO₂Cl+H₂SO₄+HCl

Overall Reaction:

Ar+2HOSO₂Cl→ArSO₂Cl+H₂SO₄+HCl

In which Ar is a styrene unit:

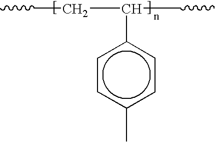

In order to obtain ion exchange groups desirable for conductivity, it is desirable to obtain sulfonic groups (—SO₃H) starting from the halogen sulfonic groups (for example —SO₂Cl) by a hydrolysis step, using a base, according to the following reaction scheme:

ArSO₂Cl+NaOH→ArSO₃H+NaCl

In order to ensure the conversion of all halogen sulfonic groups, it is a general rule to use an excess amount of the aforesaid base. Nevertheless, this operation involves the formation of sulfonate groups (—SO₃⁻Na⁺, if NaOH is used as base) in addition to the expected sulfonic groups (—SO₃H). The presence of such sulfonate groups is limiting for the adequate functioning of the membrane, since it interrupts the arrangement of the sulfonic groups inside the nanocavities of the clathrates, leading to a reduction of the proton conductivity of the membrane since the sulfonate groups coordinate less water molecules and thus less protons.

This drawback is overcome by inserting an acidification step following the aforesaid hydrolysis step, using an acid to form sulfonic groups starting from the sulfonate groups, according to the following reaction scheme:

ArSO₃—Na++HCl→ArSO₃H+NaCl

As is evident from the aforesaid reaction scheme, the acidification involves the ionic exchange (substitution) of the metal cation (for example Na⁺) of the sulfonate groups with the cation H⁺ coming from the acid. Preferably, the acid is a strong acid chosen from the group which comprises all strong acids, preferably hydrochloric acid (HCl). Preferably, the acidification step of the polyelectrolyte membrane obtained with an acid is carried out by immersing the film in an acidic solution for about 1-72 hours, and preferably 18 hours.

At the end of the acidification step, the sulfonic group (—SO₃H) content in the membrane is in the range of about 1-60%, preferably about 5-40% of the molar concentration. The sulfonate group (—SO₃⁻Y⁺, in which Y is for example Na in the case of the above reaction scheme) content in the membrane, at the end of the acidification step, is preferably less than about 0.1%. According to a particularly preferred embodiment, the membrane obtained at the end of the aforesaid acidification step is essentially free of sulfonate groups.

Inside the film, the solvent is partially dissolved in the amorphous domains and partially trapped in the regularly spaced nanocavities present in the crystalline phase. This forms the so-called inclusion compounds (clathrate regions). The presence of clathrate regions is desired since they provide regular pathways in the crystalline regions for the introduction of the sulfonic groups. This induces the anchoring of regularly spaced ionic groups along the polymer backbone included in the crystalline domains, advantageously resulting in effective percolation pathways for ion transport through the membrane.

In particular, according to particular embodiments, when the sulfonic groups are introduced in the syndiotactic polystyrene film in its clathrate form, effective percolation pathways for the proton transport through the membrane can be obtained even if the degree of sulfonation is lower with respect to other techniques. This confers good electrical conductivity and mechanical properties to the polyelectrolyte membrane.

In addition, it should be noted that the polyelectrolyte membrane does not typically require the insertion in the polymer of a high quantity of sulfonic groups, in order to obtain the desired electrical conductivity properties. In fact, as explained above, due to the presence of the clathrate regions which provide regular pathways in the crystalline region for the introduction of the sulfonic groups, a smaller quantity of sulfonic groups with respect to the other techniques is generally sufficient for ensuring an acceptable electrical conductivity to the final membrane. Moreover, the efficiency and arrangement of the existing sulfonic groups are further improved by obtaining sulfonic groups from sulfonate groups through the acidification step.

This is particularly advantageous since if a reduced quantity of sulfonic groups is introduced in the polymer, the mechanical properties of the polyelectrolyte membrane are preserved, while at the same time the regular arrangement of sulfonic groups along the polymer backbone included in the crystalline domains allows good electrical conductivity properties. For example, when the syndiotactic polystyrene is sulfonated in its clathrate form without subsequent acidification, the resulting polyelectrolyte membrane has good electrolyte conductivity (30 mS/cm), using a theoretical degree of sulfonation which varies from about 10% to 40% of the molar concentration.

The acidified membrane according to an embodiment absorbs a greater quantity of water due to the increase of the sulfonic groups and thus the smaller bond distance between H⁺ and —SO₃⁻ which permits every functional group to coordinate a greater number of water molecules; moreover, the cation (Na⁺) has a screening effect on the sulfonic groups, protecting them from degradation (it increases the degradation temperature) and preserving them unaltered beyond the polystyrene degradation temperature (it increases the final residue). Such effect can be traced to the cation effect, according to which, the greater affinity of the —SO₃⁻ groups for the Na⁺ ions and the greater ionic radius of the latter generates ionic interactions, which are stronger than hydrogen bonds (which are established for the —SO₃H groups) and reduce the mobility of the polymer chains.

The acidification step, by converting the sulfonate groups to sulfonic groups, then allows, with solfonation or a sulfonating agent being equal, making polyelectrolyte membranes with a higher conductivity, even equal to about 80 mS/cm. The method for forming the syndiotactic styrene polymer or copolymer film in clathrate form is not particularly restricted.

According to one embodiment, the preparation of the film containing at least one syndiotactic styrene polymer or copolymer in clathrate form comprises preparing a solution including at least one syndiotactic styrene polymer or copolymer in a solvent suitable to form clathrates in the at least one syndiotactic styrene polymer or copolymer, and treating the solution to form a film including the at least one syndiotactic styrene polymer or copolymer in clathrate form. Preferably the at least one syndiotactic styrene polymer or copolymer includes syndiotactic polystyrene.

Syndiotactic styrene polymers or copolymers can be prepared directly in a solvent suitable to form clathrates in the polymers/copolymers, or they can be provided in another manner. For example, the preparation of syndiotactic polystyrene can be carried out according to conventional processes. Examples of processes adapted for the preparation of syndiotactic polystyrene in its α, δ, γ or ε [ref. P. Rizzo, C. D'Aniello, A. De Girolamo Del Mauro, G. Guerra, Macromolecules, 40, 9470 (2007)] polymorph forms are described G. Guerra, V. M. Vitagliano, C. De Rosa, V. Petraccone, P. Corradini, Macromolecules 23, 1539 (1990); Y. Chatani Y. Shimane, Y. Inoue, T. Inagaki, T. Ishioka, T. Ijitsu, t. Yukinari, Polymer 33, 488 (1992); Chatani Y. et al., Polymer, 34, 1620-1624 (1993); Chatani Y., Shimane Y., Ijitsu T., Yukinari T., Polymer, 34, 1625-1629 (1993); De Rosa C., Macromolecules, 29, 8460-8465 (1996); De Rosa C., Guerra G., Petraccone V., Pirozzi B.; Macromolecules, 30, 4147-4152 (1997).

Characteristic of embodiments is that of choosing the solvent from among those suitable to form clathrates in the syndiotactic styrene polymer or copolymer used, such as, for example, syndiotactic polystyrene.

Suitable solvents for this purpose are well known in the sector, see for example A. Del Nobile, G. Mensitieri, M. T. Rapacciuolo, P. Corradini, G. Guerra, C. Manfredi, Manufactured articles of a new crystalline modification of syndiotactic polystyrene capable of forming clathrates with solvents and process for the same and Italian Patent IT 1271842; Manfredi C., Del Nobile M. A., Mensitieri G., Guerra G., Rapacciuolo M., J. Polym. Sci. Polym. Phys. Ed., 35, 133 (1997).

For example, solvents suitable to form clathrates, in particular, in syndiotactic polystyrene, can be selected from the group consisting of halogenated compounds, such as chloroform, methyl chloride, methylene chloride, carbon tetrachloride, dichloroethane, trichloroethylene, tetrachloroethylene, dibromoethane, methyl iodide, aromatic compounds such as benzene, o-dichlorobenzene, toluene, styrene, cyclic compounds such as cyclohexane, tetrahydrofuran and compounds containing sulphur, such as, for example, carbon sulfide, etc. Preferably the solvent is chosen from chloroform, methylene chloride, o-dichlorobenzene and toluene, and more particularly, the solvent is preferably chloroform.

In the preparation of the solution, the syndiotactic styrene polymer or copolymer is heated in the desired solvent to a temperature suitable for dissolving it. The dissolving temperature depends on the composition of the polymer and on the type of solvent used. Generally, the dissolving temperature is in the range of about 50° C., and the boiling temperature of the solvent used.

In accordance with another embodiment, the preparation of the film containing at least one syndiotactic styrene polymer or copolymer in clathrate form comprises providing a film of at least one syndiotactic styrene polymer or copolymer, and contacting the film of at least one syndiotactic styrene polymer or copolymer with a solvent suitable to form clathrates in the at least one syndiotactic styrene polymer or copolymer for a time sufficient to form the clathrate, obtaining a film in which the at least one syndiotactic styrene polymer or copolymer is in clathrate form.

In the method, the introduction of halogen sulfonic groups in the syndiotactic styrene polymer or copolymer, in particular, in the syndiotactic polystyrene, is achieved by making the syndiotactic styrene polymer or copolymer film react in its clathrate form with halogen sulfonic acid. Preferably, for the introduction of sulfonic groups, a solution of chlorosulfonic acid in chloroform is employed. Preferably, the at least one syndiotactic styrene polymer or copolymer includes syndiotactic polystyrene in a polymorph form, in particular α, δ, γ or ε form.

The film can be produced by different techniques, such as solution-casting, melt-press, injection molding, blow molding, etc. In one embodiment, a solution-casting method is used in which the syndiotactic styrene polymer or copolymer held in a solution state in a solvent suitable to form clathrates is poured on a substrate, and the solvent is removed to form a film. The substrate can be of any type, for example, a glass plate, a metal plate, such as a stainless steel plate, or a resin sheet, for example, a Teflon sheet or a polyimide sheet. It can have smooth surfaces or irregularities on its surface.

After pouring on the substrate the solution prepared by dissolving the employed syndiotactic styrene polymer or copolymer in a suitable solvent. The solvent is removed from the resulting film. In particular, during the evaporation of the solvent, the solution becomes denser, and the resulting polymer/solvent mixture first forms a gel, and then a solid film made of amorphous and crystalline regions.

The concentration of the syndiotactic polystyrene in the solution used in the solution-casting method is not particularly restricted and is preferably in the range of about 0.03 up to 10% by weight, and more preferably about 0.1 up to 5% by weight. The treatment temperature after removal of the solvent varies according to the type of solvent used and is preferably in the range of about −50° up to 150° C. The removal of the solvent can be conducted under a vacuum, or by placing the membrane in a gaseous flow.

In accordance with another aspect for the preparation of the film of at least one syndiotactic styrene polymer or copolymer, a melt-press method is used comprising heating a syndiotactic styrene polymer or copolymer to a temperature greater than the melting temperature, while the syndiotactic styrene polymer or copolymer is subjected to a pressure in the range of about 100-400 bars for a time in the range of about 1-10 minutes, obtaining a melt. The method also includes rapidly cooling the melt to a temperature in the range of about −100° C.-200° C., in particular 30-200° C., obtaining a film of the syndiotactic styrene polymer or copolymer in α′ crystalline form and/or in amorphous form.

Preferably, the syndiotactic styrene polymer or copolymer is a syndiotactic polystyrene and the heating is carried out at a temperature greater than about 300° C. Preferably, the film is obtained with a uniform thickness in the range of about 10-200 μm. Preferably, the syndiotactic styrene polymer or copolymer is heated to a temperature higher than about 300° C. and is subjected to a pressure of about 250 bars for about 5 minutes, obtaining a substantially uniform melt having a controlled thickness of about 100 μm. Preferably, the cooling step includes the cold crystallization method, which leads to the formation of a film in α′ crystalline form following a thermal annealing between about 30 and 200° C. of an amorphous film.

It was found that the preparation of a film of at least one syndiotactic styrene polymer or copolymer by a melt-press has some advantages, such as the formation of a uniform film with homogenous thickness. This, in turn, determines the possibility of making, by the film, electrolyte membranes with an advantageously more homogenous morphology.

To this end, it should be noted that the syndiotactic styrene polymer or copolymer film obtained with the melt-press method, when placed in a clathrating solvent, passes from its α′ crystalline form or from its amorphous form to the δ form. The latter is suitable for the sulfonation step of the film in the scope of making electrolyte membranes. Moreover, the melt-press method permits eliminating the use of the solvent in the initial steps of the membrane preparation process, rendering the process faster and simpler.

The polyelectrolyte membrane preferably has a ion exchange capacity of about 0.03 milli-equivalent/g or greater, more preferably in the range of about 0.05-5 milli-equivalent/g on the basis of weight of dried membrane. The thickness of the polyelectrolyte membrane is not particularly restricted and is preferably from about 0.1 up to 1000 microns, more preferably about 1-200 microns. When the thickness of the polyelectrolyte membrane is less than the lower value indicated above, the polyelectrolyte membrane does not have a practically usable strength. When the thickness of the polyelectrolyte membrane is greater than the indicated maximum value, the resistance of the electrolyte membrane tends to be too large, and this results in deteriorated power generation performances of fuel cells obtained therefrom.

The thickness of the membrane can be controlled by adjusting the concentration of the syndiotactic polystyrene in the solution or the thickness of the cover film of the casting formed on the substrate in the case of the solution-casting method, and adjusting the thickness of the spacer, the channel of the mold, the speed of withdrawal, etc. in the case of melt-press or melt-extrusion methods. The polyelectrolyte membrane can be reinforced with a woven fabric if desired. The polyelectrolyte membrane can be used for many electrochemical applications, in particular for fuel cells and the like.

The fuel cell is a device for continuously generating electrical power or energy by continuously replenishing a fuel such as hydrogen and oxygen or air and simultaneously continuously discharging the reaction products, mainly including water, therefrom.

As the hydrogen source, there may be hydrogen itself, as well as hydrogen derived from various hydrogen-based fuels, such as natural gas, methane, alcohol and the like. Also, the fuel cell generally comprises electrodes, electrolytes, fuel feed devices, product discharge devices, etc. The electrodes include electrode active materials.

The fuel cell comprises the aforesaid polyelectrolyte membrane as an electrolyte. The polyelectrolyte membrane can achieve good electrical conductivity, reduced water permeability, and also have considerable advantages in terms of high power density. In addition, the use of the membrane allows avoiding problems, which are normally encountered in fuel cells using a liquid electrolyte such as PEMFC cells and alkaline fuel cells.

A particularly interesting application of the polyelectrolyte membrane is in the large-scale production of reduced size fuel cells, to be used as power generators for portable power sources. In the last few years, considerable progress has been made in the development of portable electronic devices. The batteries, which have advanced technologically, currently represent one of the only possibilities for devices requiring electrical power up to 100 W.

Nevertheless, the main limitations of batteries for applications, such as cell phones and laptop computers, are the large weight and volume, along with the small energy density that limits the operation period before recharging. Battery replacement also has recycling problems, since base materials cannot be reused. Such a problem can be resolved by using a methanol or hydrogen fuel cell comprising a polyelectrolyte membrane instead of the conventional batteries.

In fact, a fuel cell according to an embodiment can provide an energy density 30 times higher than a conventional Ni/Cd battery.

Moreover, the hydrogen-rich fuels have an electrochemical energy density two orders of magnitude higher than a battery on a weight basis.

### BRIEF DESCRIPTION OF THE DRAWINGS

FIG. 1 shows a schematic representation of a fuel cell according to the prior art.

FIGS. 2a and 2b show a comparison between the thermogravimetric curves (thermogravimetric analysis, TGA) and the thermograms (differential calorimetric scans, DSC) for two sulfonated membrane samples, one of which was acidified according to the method of the invention;

FIG. 3 shows the thermograms for two sulfonated membrane samples, of which one was acidified according to the method of the invention and the other was not acidified;

FIG. 4 shows the proton conductivity at 100% humidity as a function of the temperature in a 15.9% sulfonated sample;

FIG. 5 shows the conductivity as a function of the molar degree of sulfonation measured at 31.5° C. in both liquid and vapor phase at 100% humidity; and

FIG. 6 shows the conductivity as a function of time for three samples: one non-acidified and two acidified.

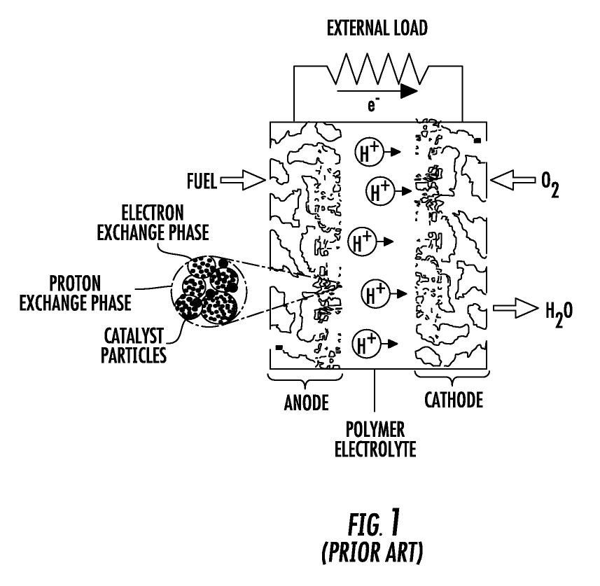

### DETAILED DESCRIPTION OF THE PREFERRED EMBODIMENTS

The characteristics and advantages of the polyelectrolyte membrane in accordance with the present invention will be more evident from the following description, given through non-limiting examples with reference to the attached drawings.

### Example 1

### Preparation of Polyelectrolyte Membranes Containing Syndiotactic Polystyrene in its Clathrate Form and with and without the Acidification Step

Two samples (A and B) of syndiotactic polystyrene having a weight indicated in Table 1 were individually mixed with 20 ml of chloroform (about 99.9% HPLC grade, Aldrich Chemicals) and heated to about 100° for about 1.5 hours until the polymer was completely dissolved.

In accordance with the solution-casting method, the solutions thus obtained were individually cooled to room temperature and then poured in a Petri dish until partial evaporation of the solvent was achieved, thus obtaining a film. Each film was then sulfonated, using chlorosulfonic acid, in order to introduce ionic groups into the SPS having polymorphic clathrate form. A procedure was used, which had been modified from the method for the chlorosulfonation of styrene divinylbenzene copolymers used by Rabia et al, React. Function. Polym. 28, 279 (1996).

In accordance with this procedure, each of the aforesaid films produced by the solution-casting method was immersed in about 40 ml of an associated solution of chloroform and chlorosulfonic acid (99% Aldrich Chemicals) at room temperature for about 4 hours. The volume content of chlorosulfonic acid is indicated in Table 1 for each solution used.

During the immersion time, each film underwent sulfonation, and the degree of sulfonation was controlled by the chlorosulfonic acid concentration according to conventional techniques.

TABLE 1

| | | Chlorosulfonic acid | Sulfonation |
|---|---|---|---|
| Sample | s-PS (g) | (ml) | (%) |
| A | 1.0187 | 0.76 | 35.3 |
| B | 1.0187 | 0.76 | 35.3 |

After the desired reaction time, each sulfonated membrane obtained was washed with deionised water to facilitate the complete removal of the residual sulfonating reagent from the functionalised SPS film. The sulfonated membrane was then stirred in a 1M NaOH (97% Sodium Hydroxide, 20-40 Mesh bead, Aldrich Chemicals) solution at room temperature to hydrolyse the sulfonyl chloride to sulfonic group according to the following equation:

ArSO₂Cl+NaOH→ArSO₃H+NaCl

Then, the membranes were washed in water and dried in an oven under a vacuum, at about 60° C. for about 1 hour. The membrane B was then immersed under mechanical stirring in a 1M HCl (37% hydrochloric acid, Sigma-Aldrich) solution at room temperature for about 10 hours in order to obtain sulfonic groups (SO₃H) from the (—SO₃⁻Na⁺) groups. Finally, the membrane B was washed with water and dried in an oven under a vacuum, at about 60° C. for about 1 hour.

### Characterization Methods and Results

The two membranes were characterized in relation to their thermal properties and behavior. A TA Instrument 2910 Differential Scanning Calorimeter (DSC), equipped with a nitrogen purge was used to study the thermal properties of the syndiotactic polystyrene and sulfonated syndiotactic polystyrene. A TA Instrument 2950 Thermogravimetric balance equipped with a nitrogen purge was used to study the thermal behavior of sPS and sulfonated sPS. Infrared spectra were obtained with a Nicolet Nexus FT-IR. The membranes were characterized through FT-IR spectroscopy to ascertain the presence of sulfonate groups attached to the phenyl rings.

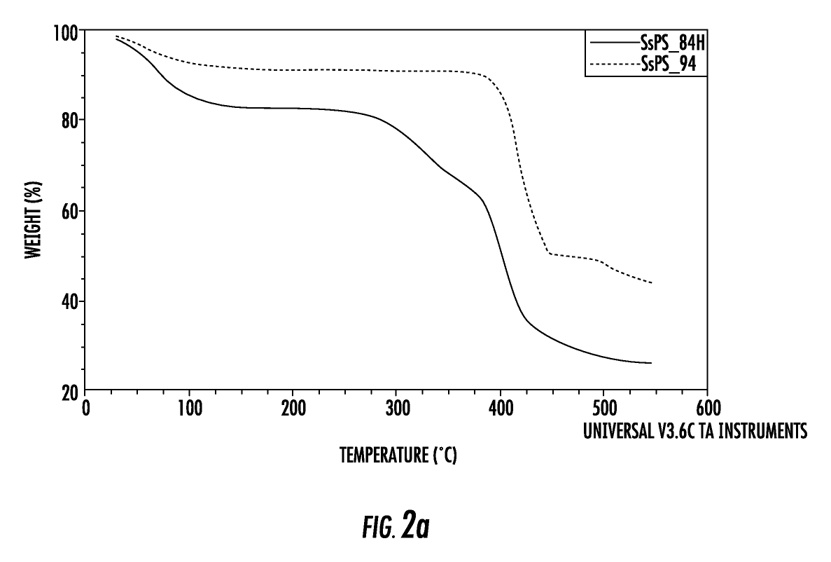

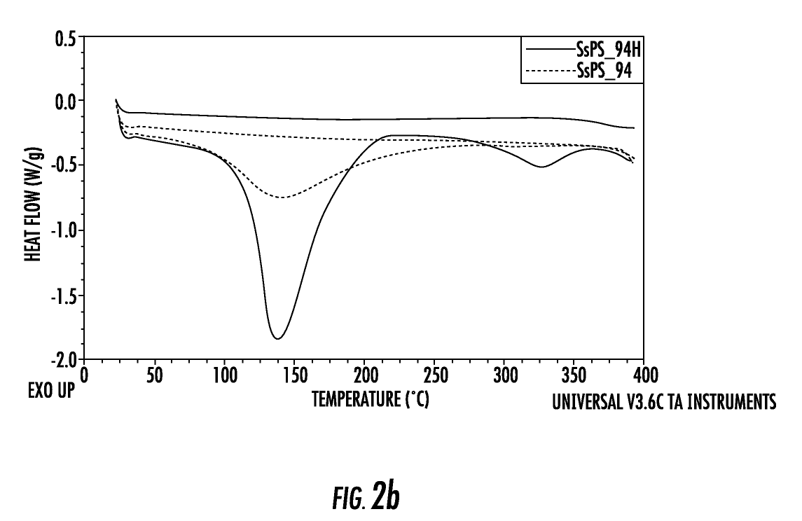

FIGS. 2a and 2b show a comparison between the thermogravimetric curves (thermogravimetric analysis, TGA) and the thermograms (differential calorimetric scans, DSC) for the two 35.3% sulfonated samples, A and B. For the thermal scanning, the heating speed is about 10° C./min.

From the figure, the following points are evident: the acidified membrane absorbs a greater amount of water, due to the smaller bond distance between H⁺ and —SO₃⁻ which permits every functional group to coordinate a greater number of water molecules; the cation (Na⁺) has a screening effect on the sulfonic groups, protecting them from degradation (it increases the degradation temperature) and preserving them unaltered beyond the degradation temperature of polystyrene (it increases the final residue); the appearance of the endothermal degradation of the —SO₃H groups between about 280° and about 380° C. (zone circled in gray); and Tₘ (melting point) entirely disappears in the non-acidified membranes at high sulfonation degrees, while in the case of the acidified membranes, with the same sulfonation degree, a melting is observed at about 270° C. due to the presence of additional sulfonic groups obtained from the conversion of the sulfonate groups, which since they are smaller favor crystallinity.

Such differences can be traced to the effect of the cation, according to which the greater affinity of the —SO₃⁻ groups for the Na⁺ ions and the greater ionic radius of the latter generate ionic interactions, which are stronger than the hydrogen bonds (which are established for the —SO₃H groups) and reduce the mobility of the polymer chains.

### Example 2

### Effect of the Cation on the Diminution of the Melting Temperature

The preparation of the membranes A and B of example 1 was repeated using a sulfonation degree for both membranes of about 9.9% mol. The membranes A and B were respectively non-acidified and acidified, as in example 1.

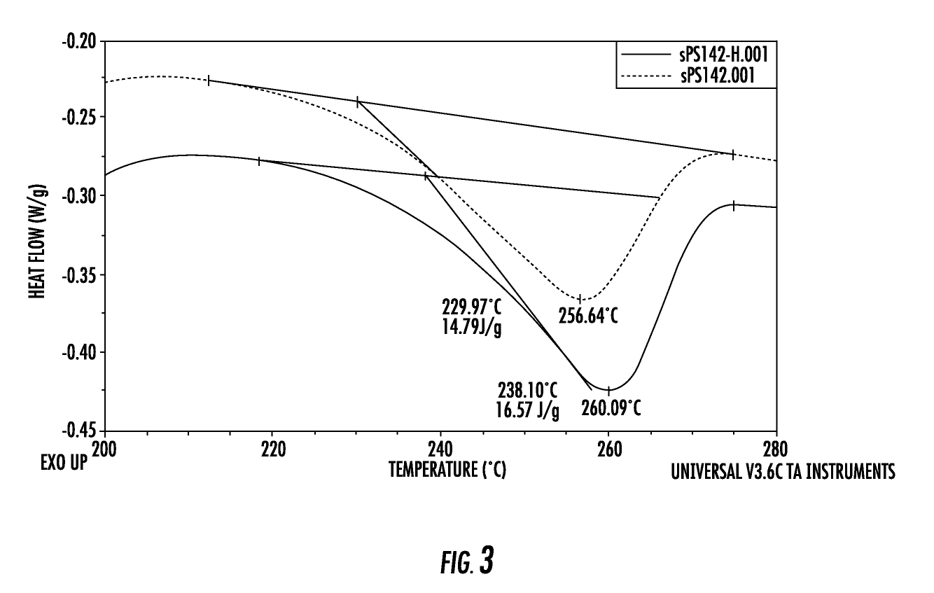

FIG. 3 shows the effect of the cation on the lowering of the melting temperature on two 9.9% mol sulfonated membranes. It can be seen that in the case of the non-acidified membrane, not only is the melting temperature moved to lower values, but an approximately 10% reduction of the crystallinity is also detected.

### Example 3

### Electrical Characterization of Sulfonated Membranes of Syndiotactic Polystyrene (sPS)

In the membranes of partially sulfonated syndiotactic polystyrene, the sulfonate groups are introduced into the polymer structure of the sPS by the sulfonation process described above. The proton conductivity is linked to the number of sulfonic groups inserted (degree of sulfonation), to the temperature and the hydration condition. For such reason, different proton conductivity measurement sets were carried out with the variation of the aforesaid parameters.

### Preliminary Proton Conductivity Measurements

The membranes were immersed in distilled water at room temperature for about 2 hours and then, after having wiped off the water attached on the surface of the membrane, the electrical conductivity of the membrane was measured. Membrane conductivity was determined from the lateral resistance of the membrane, measured using a four-points-probe electrochemical impedance spectroscopic technique.

A BekkTech conductivity cell was used in order to provide a simple fixture for loading the membrane and performing four-points-probe conductivity tests. The cell had two platinum foil outer current-carrying electrodes and two platinum wire inner potential-sensing electrodes. The inner electrodes had a 0.75 mm diameter and were placed at a distance of about 0.425 cm. The membrane sample was cut into strips which were approximately 1.0 cm wide, 2 cm long and 0.02 cm thick prior to mounting in the conductivity cell. The conductivity cell with the membrane sample loaded was inserted between the cathode and anode conduction plates of the fuel cell technologies hardware.

Impedance measurements were made using a Solartron SI 1280 B electrochemical impedance analyser in order to measure the sample resistance. The instrument was used in the galvanostatic mode with an 0.01 mA AC current amplifier over a frequency range of 0.1-20,000 Hertz. A base conductivity value of the membrane of about 14 mS/cm was obtained from sample resistance measurements at room temperature.

The first proton conductivity measurements were carried out using a Bekktech four-point measurement cell, without any control system of the environmental conditions. The impedance measurements were conducted at room temperature immediately after having surface dried the samples and after having set them in the sample holder cell, so to obtain the maximum hydration condition possible without a humidity control.

In Table 1, the conductivity values at 21° C. are reported both for the sulfonated membranes of sPS (SsPS) with different theoretical sulfonation degree, and for a Nafion 117 sample used as reference.

TABLE 1
Proton conductivity of SsPS and Nafion 117 membranes

| | | | Proton |
|---|---|---|---|
| | Sulfonation | Reaction | conductivity |
| Sample | degree (% mol.) | time (h) | (mS/cm) |
| SsPS9 | 9.9 | 4 | 9 ± 2 |
| SsPS10 | 12.2 | 4 | 13 ± 2 |
| SsPS7 | 18.2 | 4 | 21 ± 2 |
| SsPS8 | 20.1 | 4 | 23 ± 3 |
| SsPS12 | 22.7 | 72 | 26 ± 4 |
| Nafion 117 | — | — | 56 ± 1 |

As expected, the conductivity increases with the degree of sulfonation and with the reaction time. In fact, all samples have an increasing sulfonation degree, with the exception of sample SsPS12 which, even if made with the same quantity of sulfonating agent as the sample SsPS8, underwent the sulfonation reaction for a longer time.

From a comparison with the Nafion membranes, it is possible to observe that the sulfonated sPS membranes show more considerable water absorption, which is particularly advantageous for conductivity at low and moderate humidity values. The data shows important results, since the conductivity values of the sulfonated sPS (˜30 mS/cm) are of the same order of magnitude as the Nafion 117 (˜60 mS/cm).

### Conductivity Measurements at 100% RH as a Function of Temperature

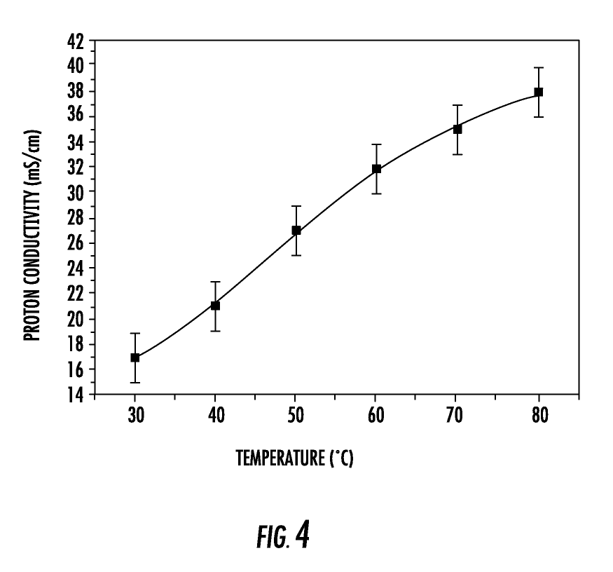

FIG. 4 shows the conductivity data at 100% humidity as a function of temperature for the sample SsPS77 (15.9% sulfonated). Such sample showed a conductivity value equal to about 18±2 mS/cm at 31.5° C. and 100% humidity in vapor phase. As expected, the proton conductivity increases with temperature. In particular, it is interesting to observe that this membrane reaches a conductivity value of about 32±3 mS/cm at 60° C., the typical functioning temperature of a DMFC.

### Conductivity Measurements as a Function of the Sulfonation Level

The first experimental data showed the correspondence between proton conductivity and sulfonation level. In order to obtain more details, a set of proton conductivity measurements was conducted on a series of differently sulfonated sPS membranes.

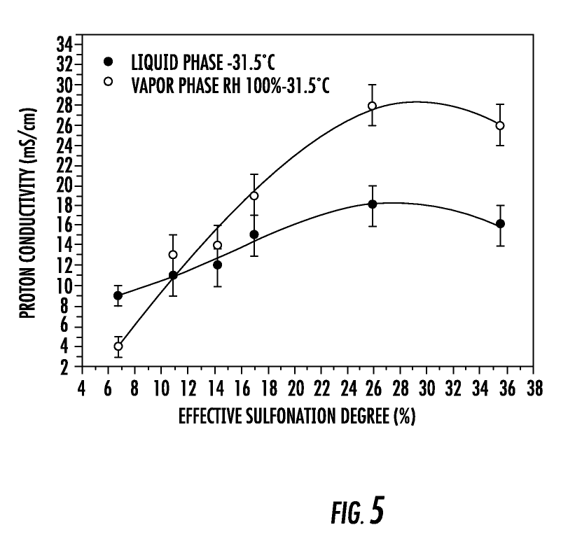

FIG. 5 shows the conductivity data as a function of the molar degree of sulfonation measured at about 31.5° C. The two sets of data refer to different hydration conditions: in liquid water (black circles) and in vapor phase at 100% relative humidity (white circles). The curve does not represent any model but rather is depicted only to guide one's view.

In both cases, the proton conductivity increases with the degree of sulfonation, until it reaches the maximum value at about 25% mol. As a matter of fact, if on one hand the increase of the sulfonation degree favors proton conductivity, on the other hand an excessive water absorption linked to more driven sulfonation causes the removal of the ionic clusters, and the consequent diminution of conductivity.

### Example 4

### Characterization of acidified Syndiotactic Polystyrene (SsPS) Sulfonated Membranes

Different samples of acidified sPS sulfonated membranes were characterized according to the method used in example 3. The first conductivity measurements showed a clear increase of the performances, but it was also necessary to study its behavior over time. Table 2 shows the results obtained on samples acidified in a solution of about 0.5M HCl for about 18 hours, measured at about 31.5° C. in liquid water, with the variation over time of the acidification data.

TABLE 2
Conductivity of a series of samples at 31.5° C. in liquid
water, with the variation over time of the acidification data.

| | Non-acidified | | | | | | | |
|---|---|---|---|---|---|---|---|---|
| | sample | Acidified sample conductivity (mS/cm) | | | | | | |
| | conductivity | 1 | 2 | 6 | 9 | 16 | 19 | 27 |
| Sample | (mS/cm) | week | week | week | week | week | week | week |
| SsPS137_H | 9 ± 2 | — | 42 ± 3 | — | 34 ± 3 | — | 34 ± 3 | — |
| SsPS139_H | 9 ± 2 | 52 ± 4 | — | — | 43 ± 3 | — | 44 ± 3 | — |
| SsPS148_H | 9 ± 2 | — | — | — | — | 27 ± 3 | — | — |
| SsPS140_H | 11 ± 2 | 31 ± 3 | — | — | 29 ± 3 | — | — | — |
| SsPS146_H | 13 ± 2 | — | — | — | — | 54 ± 4 | — | — |
| SsPS145_H | 14 ± 2 | — | — | — | — | 25 ± 3 | — | — |
| SsPS147_H | 15 ± 2 | — | — | — | — | 56 ± 4 | — | — |
| SsPS94_H | 16 ± 2 | 88 ± 5 | — | 84 ± 5 | 52 ± 4 | 35 ± 3 | — | 24 ± 2 |
| SsPS94_H1* | 16 ± 2 | 63 ± 4 | — | 57 ± 2 | — | — | — | 52 ± 2 |
| SSPS142_H | 20 ± 3 | — | — | — | — | 62 ± 4 | — | — |

*sample acidified in 1M HCl solution for about 1.5 hours

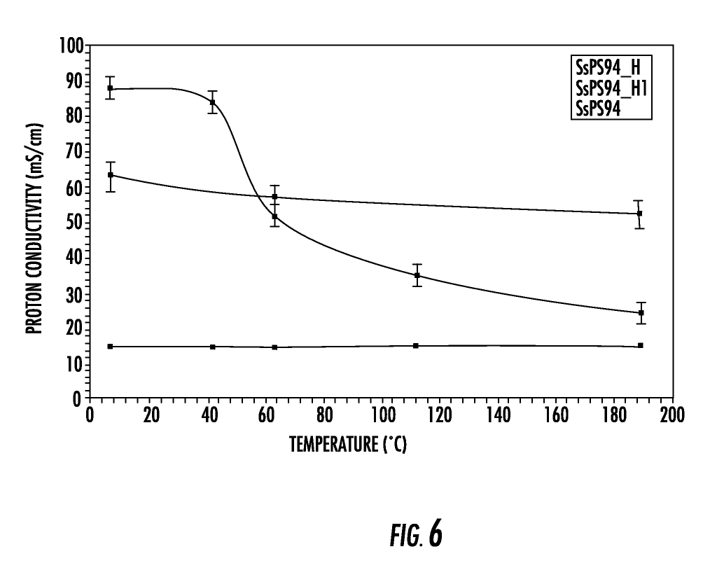

In particular, FIG. 6 shows the graph of conductivity as a function of time for the samples SsPS94 (non-acidified), SsPS94_H (acidified with a 0.5M HCl solution for about 18 hours) and SsPS94_H1 (acidified with 1.0M HCl for about 1.5 hours).

The graph shows that the acidification step in the reported cases, and in general in all tested cases (Table 2), shows a strong increase of conductivity, steadily decreasing over time. A similar situation, however, is also verified for the Nafion which undergoes a conductivity diminution of about 30% in the span of a few months. It should be added however that a different acidification methodology (SsPS94_H1) provides a membrane, which over time appears to maintain its conductivity. It is observed also that the acidification process can be repeated and is reversible.

A base value for the conductivity of the membrane of about 60 mS/cm was obtained by sample resistance measurements at about 31.5° C. The electrical conductivity measured above is suitable for numerous electrochemical applications.

### Example 5

### Characterization of Syndiotactic Polystyrene (SsPS) Sulfonated Membranes Obtained from Presses

The syndiotactic polystyrene (SsPS), placed under a press, was heated beyond its melting temperature (300° C.) and subjected to a pressure of about 250 bars for about 5 minutes, to form a uniform film with controlled thickness (about 100 μm). Subsequently, the film was rapidly cooled to obtain the SsPS film in α′ crystalline form and in amorphous form. The films obtained were placed in chloroform, and the films, thus, passed to the full delta form.

Different sPS sulfonated membrane samples obtained by press were characterized. The conductivity measurements, conducted in liquid phase at about 31.5° C., showed that the polyelectrolyte membranes made in such a manner have performances equivalent to those obtained from solution-casting. Table 3 shows the results obtained on samples of sPS film in α′ form (from α-sPS 1 to α-sPS 6) and amorphous form (a-sPS 1 and a-sPS 2) subsequently sulfonated with different sulfonation degrees according to the procedure described in the preceding examples.

TABLE 3
Conductivity of a series of samples obtained from presses

| | | | Proton |
|---|---|---|---|
| | Sulfonation | Reaction | conductivity |
| Sample | degree (% mol.) | time (h) | (mS/cm) |
| α-sPS 1 | ~9 | 8 | 9 ± 2 |
| α-sPS 2 | ~18 | 8 | 19 ± 3 |
| α-sPS 3 | ~9 | 4 | 7 ± 2 |
| α-sPS 4 | ~16 | 4 | 18 ± 3 |
| α-sPS 5 | ~10 | 24 | 10 ± 2 |
| α-sPS 6 | ~22 | 24 | 16 ± 2 |
| a-sPS 1 | ~18 | 4 | 19 ± 3 |
| a-Sps 2 | ~23 | 8 | 21 ± 3 |

By preparing the membrane by the press, it is possible to eliminate the use of the solvent, at least in this step, further reducing the environmental impact of the entire process and allowing an easier industrialization with large-scale production. Moreover, the films thus obtained have more regular morphology, allowing improved final uniformity of the polyelectrolyte membranes produced.

1-32. (canceled)

33. A polyelectrolyte membrane comprising:
at least one styrene polymer film in clathrate form having a syndiotactic configuration and having sulfonic groups;
the at least one styrene polymer film comprising less than about 0.1% sulfonate groups of the —SO₃⁻Y⁺ general formula wherein Y is a monovalent metal cation.

34. The polyelectrolyte membrane according to claim 33, wherein the monovalent metal cation is Na+.

35. The polyelectrolyte membrane according to claim 33, wherein said at least one styrene polymer film is substantially free of sulfonate groups.

36. The polyelectrolyte membrane according to claim 33, wherein said at least one styrene polymer film is selected from the group consisting of: poly(p-methylstyrene), poly(m-methylstyrene), poly(p-chlorostyrene), poly(m-chlorostyrene), poly(chloromethylstyrene), poly(bromostyrene), and poly(fluorostyrene).

37. The polyelectrolyte membrane according to claim 33, wherein said at least one styrene polymer film comprises syndiotactic polystyrene.

38. The polyelectrolyte membrane according to claim 33, wherein said sulfonic groups (—SO₃H) are in the range of about 1-60% of a molar concentration.

39. A method for producing a polyelectrolyte membrane comprising:
providing a film comprising at least one syndiotactic styrene polymer in clathrate form;
introducing halogen sulfonic groups in the film to react the film with a halogen sulfonic acid;
hydrolysing the halogen sulfonic groups with a base to obtain a polyelectrolyte membrane comprising sulfonic groups and sulfonate groups; and
acidifying the polyelectrolyte membrane with an acid to form sulfonic groups from sulfonate groups.

40. The method according to claim 39, wherein the at least one syndiotactic styrene polymer comprises syndiotactic polystyrene.

41. The method according to claim 39, wherein the halogen sulfonic acid has the general formula HOSO₂X; and wherein X is selected from Cl, Br, I, and F.

42. The method according to claim 39, wherein the halogen sulfonic acid comprises chlorosulfonic acid.

43. The method according claim 39, wherein the halogen sulfonic acid comprises a solution of a solvent selected from the group consisting of: chloroform, methyl chloride, methylene chloride, carbon tetrachloride, dichloroethane, trichloroethylene, tetrachloroethylene, dibromoethane, methyl iodide, aromatic compounds, o-dichlorobenzene, toluene, styrene, cyclic compounds, tetrahydrofuran, and sulphur compounds.

44. The method according to claim 43, wherein the solvent comprises chloroform.

45. The method according to claim 39, wherein the halogen sulfonic acid is present in solution at a concentration in the range of about 0.001-60% vol.

46. The method according to claim 39, wherein the acid comprises a strong acid.

47. The method according to claim 39, wherein the acid comprises hydrochloric acid.

48. The method according to claim 39, wherein acidifying the polyelectrolyte membrane further comprises immersing the film in an acidic solution for about 1-72 hours.

49. The method according to claim 48, wherein the film is immersed for about 18 hours.

50. The method according to claim 39, wherein providing the film further comprises:
preparing a solution comprising at least one syndiotactic styrene polymer in a solvent to form clathrates therein; and
treating the solution to form the film comprising the at least one syndiotactic styrene polymer.

51. The method according to claim 50, wherein forming the film further comprises pouring the solution on a substrate and removing the solvent.

52. The method according to claim 50, wherein the at least one syndiotactic styrene polymer comprises syndiotactic polystyrene.

53. The method according to claim 50, wherein the at least one syndiotactic styrene polymer is in a solution of a solvent selected from the group consisting of: chloroform, methyl chloride, methylene chloride, carbon tetrachloride, dichloroethane, trichloroethylene, tetrachloroethylene, dibromoethane, methyl iodide, benzene, o-dichlorobenzene, toluene, styrene, cyclohexane, tetrahydrofuran, and carbon sulphide.

54. The method according to claim 53, wherein the at least one syndiotactic styrene polymer comprises chloroform.

55. The method according to claim 39, wherein providing a film further comprises contacting the film with a solvent to form clathrates in the at least one syndiotactic styrene polymer, for a time sufficient to form the clathrate to obtain a film; and wherein the at least one syndiotactic styrene polymer is in clathrate form.

56. The method according to claim 55, wherein the at least one syndiotactic styrene polymer comprises syndiotactic polystyrene.

57. The method according to claim 55, wherein the halogen sulfonic acid comprises chlorosulfonic acid in a chloroform solution.

58. The method according to claim 55, wherein the at least one syndiotactic styrene polymer comprises its α, δ, γ or ε polymorph form; and wherein the film is obtained by one of a melt-press and melt-extrusion.

59. The method according to claim 55, wherein contacting the film further comprises immersing the film in a solvent suitable to form clathrates for a time sufficient to form the clathrates.

60. An electrochemical device comprising:
a polyelectrolyte membrane comprising
at least one styrene polymer film in clathrate form having a syndiotactic configuration and having sulfonic groups,
the at least one styrene polymer film comprising less than about 0.1% sulfonate groups of the —SO₃⁻Y⁺ general formula wherein Y is a monovalent metal cation.

61. The electrochemical device according to claim 60, wherein said electrochemical device comprises a fuel cell.

62. The electrochemical device according to claim 60, wherein the at least one styrene polymer film is substantially free of sulfonate groups.

63. A method for preparing a film of a syndiotactic styrene polymer by melt-press, the method comprising:
heating a syndiotactic styrene polymer to a temperature greater than a melting temperature while the syndiotactic styrene polymer is subjected to a pressure in the range of about 100-400 bars for a time in the range of about 1-10 minutes to obtain a melt; and
rapidly cooling the melt to a temperature in the range of about −100-200° C. to obtain a syndiotactic styrene polymer film.

64. The method according to claim 63, wherein the syndiotactic styrene polymer film is in at least one of a α′ crystalline form and amorphous form.

65. The method according to claim 63, wherein the syndiotactic polymer comprises syndiotactic polystyrene; and
wherein the heating is at a temperature greater than 300° C.

66. The method according to claim 64, wherein the film comprises a uniform thickness in the range of about 10-200 μm.

67. The method according to claim 64, wherein the syndiotactic polystyrene is heated at a temperature greater than 300° C. and pressurized at about 250 bars for about 5 minutes to obtain the melt; and wherein the melt has substantially uniform thickness equal to about 100 μm.
